(19) United States
(12) Patent Application Publication
(10) Pub. No.: US 2017/0089409 A1
(43) Pub. Date: Mar. 30, 2017

(54) Liquid Cooled Fan Clutch

(71) Applicant: Ford Global Technologies, LLC, Dearborn, MI (US)

(72) Inventors: Meisam Mehravaran, Oak Park, MI (US); Gregory Bowlby, Ann Arbor, MI (US)

(21) Appl. No.: 14/868,752

(22) Filed: Sep. 29, 2015

(51) Int. Cl. F16D 35/02; F01P 5/12

(52) U.S. Cl. CPC F16D 35/027; F16D 35/028; F16D 35/024; F01P 5/12; F16D 2300/0214

(57) ABSTRACT

A liquid cooled viscous fan clutch transfers torque from a driving plate driven by an engine crankshaft to a driven plate connected to a cooling fan. Heat generated in a working fluid is transferred to a second fluid, such as engine coolant or transmission fluid, flowing between the driven plate and a stationary housing. A controllable valve may be closed to block circulation of working fluid, trapping working fluid in a reservoir, to disengage the clutch. Rotation of the driven plate provides the motive force to circulate the coolant or transmission fluid.

### TECHNICAL FIELD

This disclosure relates to the field of automotive fan clutches. More particularly, the disclosure pertains to a viscous fan clutch having a stationary housing and liquid cooling of the working fluid.

### BACKGROUND

Many automotive engines are cooled with liquid coolant. The coolant absorbs heat while circulating within the engine and then transfers that heat to ambient air while circulating through a radiator. During operation in the most demanding operating conditions, an engine driven fan may be used to increase the flow of ambient air through the radiator. In less demanding conditions, it is desirable not to operate the fan to reduce the load on the engine. To achieve this intermittent fan operation, the engine crankshaft may drive the fan via either an actively controlled or thermostatically controlled fan clutch.

A fan clutch is illustrated in FIG. 1. Input shaft 10 is driven by the engine crankshaft either directly or via some power transfer mechanism such as an accessory drive belt. Output shaft 12 drives the fan. Input plate 14 is fixed to input shaft 10 while output plate 16 is fixed to output shaft 12 via a clutch cover 18. Ribs on input plate 14 are interspersed with ribs on output plate 16 such that the ribs are close to one another but do not touch. To engage the clutch, a working fluid is released from reservoir 20. As the fluid flows through the narrow gap between the ribs, viscous shear in the fluid exerts torque on the input plate and output plate. This narrow gap is called the working zone. The magnitude of the torque depends upon the relative speed between the plates and on the quantity of fluid in the working zone. When the fluid reaches the perimeter of the working zone, it is moving circumferentially. Some of the fluid enters return channel 22 in the clutch cover. If the output shaft is moving slower than the input shaft, then the fluid slows as it enters the return channel, causing an increase in pressure. When the speed difference between the input and output plates is sufficient, the increased pressure forces the fluid through return channel 22, against centrifugal force, back to reservoir 20. Thus, in the engaged state, fluid circulates continuously from the reservoir, through the working zone, through the return channel, and back to the reservoir. The output shaft speed stabilizes at a speed less than the input shaft speed.

To disengage the clutch, valve 24 is moved into a position in which it blocks the flow of fluid out of the reservoir 20. Once the fluid that was in the working zone exits the working zone, all torque transfer stops. Once the torque capacity is reduced, drag causes the fan to slow down. As the fan slows down, all of the fluid is returned to reservoir 20 through return channel 22. The position of valve 24 may be controlled via an actuator 26. For example, actuator 26 may be a stationary electro-magnetic actuator that pulls valve 24 into the engaged position shown in FIG. 1 by exerting a magnetic force. A return spring 28 pushes the valve into the disengaged position when the magnetic force is removed.

### SUMMARY OF THE DISCLOSURE

A viscous fan clutch includes input and output shafts, drive and driven plates, and a stationary housing. The drive plate is fixed to the input shaft while the driven plate is fixed to the output shaft. The drive plate and the driven plate each include a plurality of cylindrical ridges which are interspersed to define a working zone. The working zone is part of a working fluid circuit. Viscous shear acting on a working fluid in the working zone exerts torque on the driven plate. A coolant circuit is defined between the driven plate and the stationary housing and is sealed from the working fluid circuit. Heat generated by viscous shear is transferred through the driven plate to a cooling fluid in the coolant circuit. The working fluid circuit may include a reservoir and a valve configured to selectively block the flow of fluid from the reservoir into the working zone. The valve may be biased in an axial direction by an electro-magnetic actuator. The driven plate may include a plurality of blades to increase the convective area. The bladed may also propel coolant through the cooling circuit.

A clutch includes a housing, a driven plate, and a driving plate. The driving and driven plates are each supported for rotation within the housing. The driving plate and the driven plate define a working circuit. A working fluid is circulated through the working circuit in response to rotation of the driving plate. The driven plate and the housing define a coolant circuit that is sealed from the working circuit. A plurality of cylindrical plates of the driving plate may be interspersed with a plurality of cylindrical plates of the driven plate to define a working zone within the working circuit. A radial passageway through the driven plate may convey working fluid from the working zone to a reservoir in response to a speed difference between the driving plate and the driven plate. A valve may be configured to selectively block flow of the working fluid from the reservoir to the working zone. An electro-magnetic actuator may move the valve in an axial direction. A plurality of bladed may extend from the driven plate. In addition to providing additional convective surface area, these blades may propel a cooling fluid through the cooling circuit.

A powertrain includes an engine, a radiator, a fan, a clutch, and plumbing. The fan is configured to increase airflow through the radiator. The clutch is configured to selectively transfer power from the engine to the fan. When engaged, the clutch also pumps fluid from an inlet to an outlet. The plumbing routes coolant from the engine to the inlet and from the outlet to the radiator. The clutch may be a viscous clutch including a housing fixed to the engine, a driven plate, and a driving plate. The driven plate and the housing may define a coolant circuit between the inlet and the outlet. Blades may extend from the driven plate to propel the coolant from the inlet to the outlet.

### BRIEF DESCRIPTION OF THE DRAWINGS

FIG. 1 is a cross sectional diagram of a prior art viscous fan clutch.

FIG. 2 is a schematic diagram of a vehicle powertrain including a fan clutch cooled with engine coolant.

FIG. 3 is a cross sectional diagram of a liquid cooled fan clutch suitable for use in the powertrain of FIG. 2.

FIG. 4 is an end view of a liquid cooled fan clutch suitable for use in the powertrain of FIG. 2.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

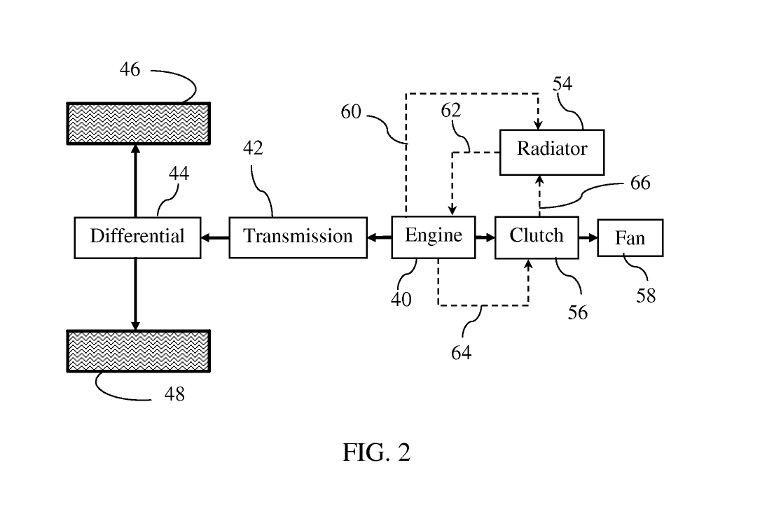

FIG. 2 schematically illustrates a vehicle powertrain. The flow of mechanical power is illustrated by solid lines. Dashed lines indicate the flow of engine coolant. Engine 40 generates power to turn a crankshaft by burning fuel. A transmission 42 conditions the mechanical power by adjusting the speed and torque based on current vehicle needs. At low speed, transmission 42 reduces the speed and multiplies the torque to improve performance. At higher speed, transmission 42 increases the speed such that the engine can run at an efficient crankshaft speed. Differential 44 divides the power between left and right drive wheels 46 and 48 while permitting slight speed differences as the vehicle turns.

Heat is removed from the engine by circulating engine coolant through the engine block and through radiator 54 via coolant lines 60 and 62. A thermostatic valve shuts off circulation through the radiator whenever the engine coolant is below a desired operating temperature. The engine coolant may also circulate through a heat exchanger called a heater core when cabin heat is requested. To control the temperature of the transmission fluid, the transmission fluid may be circulated through radiator 54 (although separated from engine coolant) or may be circulated through a liquid to liquid heat exchanger to transfer heat to engine coolant. Both the engine and the transmission operate less efficiently when the temperature is below the normal operating temperature, so warming up quickly to the normal operating temperature is desirable. During heavy load operating conditions, such as towing a trailer up an incline, the natural flow of ambient air through radiator 54 may be insufficient to control the temperature of the engine coolant. In these conditions, clutch 56 may engaged to drive fan 58 to increase the flow rate of ambient air through radiator 54. When clutch 56 is fully or partially engaged, some of the engine power is diverted to the fan as opposed to propelling the vehicle, reducing vehicle performance. Therefore, it is desirable to engage clutch 56 only when necessary and only to the degree necessary.

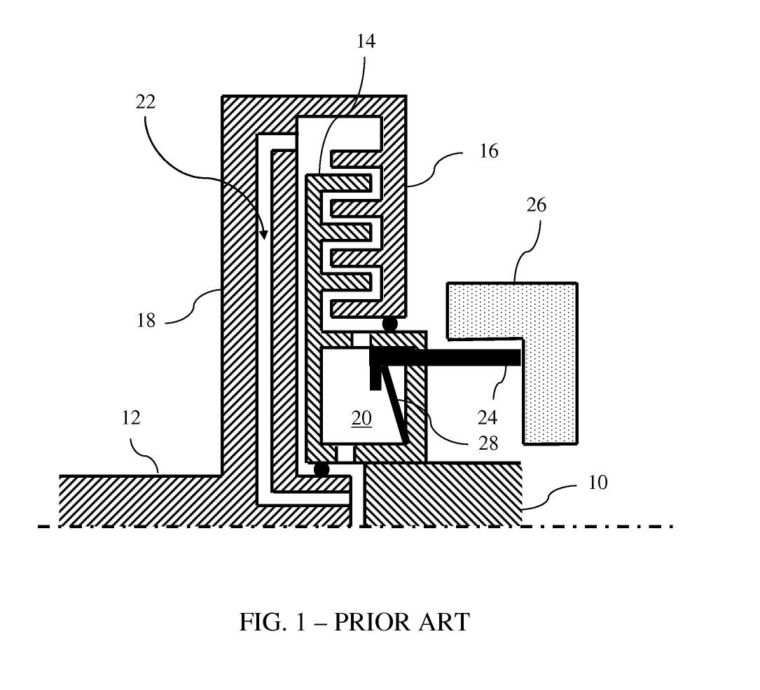

When a viscous fan clutch is transferring torque, heat is generated in the working fluid. The rate of heat generation is proportional to the torque and also proportional to the speed difference between the input shaft and the output shaft. In the prior art fan clutch of FIG. 1, the only significant mechanism for dissipating this heat is via convection to ambient air through either output plate 16 or cover 18. Even when these parts are designed with fins to facilitate convection, the heat dissipation capability is limited. Consequently, the clutch must be carefully controlled to avoid operation with combinations of speeds and torque capacity that would generate excessive heat in the working fluid. When the engine speed is high, the clutch must either be disengaged to reduce the torque or engaged sufficiently to reduce the speed difference. Operation at intermediate torque capacities with substantial slip must be avoided. This limits the control system's ability to set the fan speed to the optimum level to provide adequate engine cooling with minimum parasitic loss.

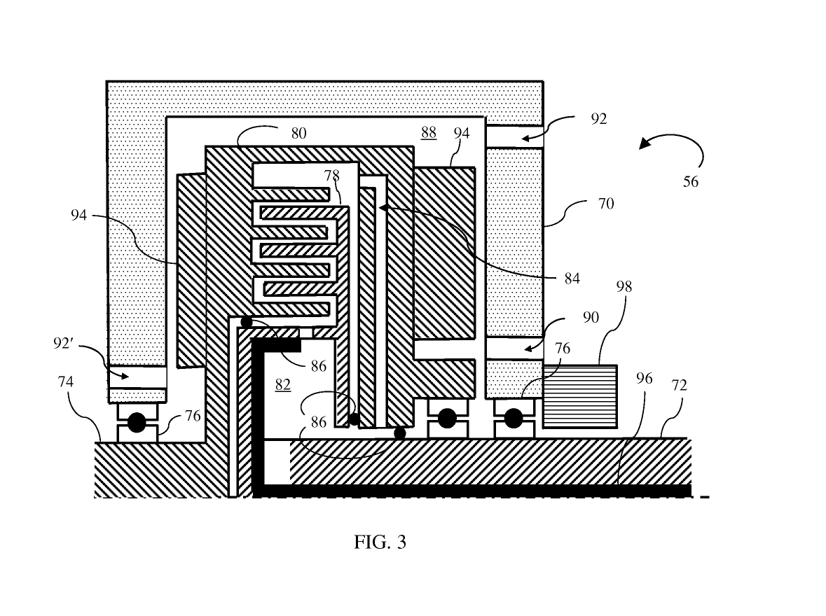

Fan clutch 56 of FIG. 2 provides an additional heat dissipation mechanism by routing coolant from the engine to the clutch via coolant line 64 and then back to the radiantor via coolant line 66. The coolant then returns to the engine via coolant line 62. FIG. 3 shows a fan clutch configured to transfer heat from the working fluid to the transmission fluid. A stationary clutch housing directs the transmission fluid flow past the driven plate providing an opportunity for heat transfer. In alternative embodiments, engine coolant may be routed through clutch 56 as opposed to transmission fluid.

A viscous fan clutch 56 with a stationary housing 70 and liquid cooling is illustrated in FIG. 3. Input shaft 72 and output shaft 74 are both supported for rotation by bearings 76, which may be ball bearings or roller bearings. Input shaft 72 is drivably connected to the engine crankshaft either directly or via some power transfer mechanism such as an accessory drive belt. Output shaft 74 drives the fan. Driving plate 78 is fixed to input shaft 72 while driven plate 80 is fixed to output shaft 74. Cylindrical ribs on driving plate 78 are interspersed with cylindrical ribs on driven plate 80 such that the ribs are close to one another but do not touch. To engage the clutch, a working fluid is released from reservoir 82. As the fluid flows between through the narrow gap between the ribs, called the working zone, viscous shear in the fluid exerts torque on driving plate 78 and the driven plate 80. The magnitude of the torque depends upon the relative speed between the plates and on the quantity of fluid in the working zone. When the fluid reaches the perimeter of the working zone, the driving plate propels the fluid circumferentially around the interior of housing 70. After exiting the working zone, the fluid enters return channel 84 near the top of the housing 70. Momentum of the fluid imparted by the driving plate 78 propels the fluid through return channel 84, overcoming centrifugal forces. From return channel 84, the fluid flows back to reservoir 82. Seals 86 define the direct the flow of working fluid through the working fluid circuit including reservoir 82, the working zone, and return channel 84. As the output shaft speed approaches the input shaft speed, the torque capacity decreases due to reduced shear rate in the working zone. The output shaft speed stabilizes at a speed slightly less than the input shaft speed.

A coolant circuit 88 is formed between housing 70 and driven plate 80. Engine coolant is routed from circuit 64 to inlet 90, through coolant circuit 88 to outlet 92, and then back to circuit 66. Alternatively, transmission fluid may be circulated through the coolant circuit. Heat that is generated in the working fluid from viscosity is transferred from the working fluid to driven plate 80 and then into the coolant flowing through coolant circuit 88. Driven plate 80 may include a number of blades 94 which propel the coolant through the coolant circuit. The blades also increase the surface area available for heat transfer to the coolant. The pumping action of the blades may be the sole force propelling coolant through the clutch or may be a supplement to an external pressure source. This pumping action increases the flow of engine coolant through the radiator to increase engine cooling thereby magnifying the effect of engaging the fan. Alternatively, outlet 92′ may be located on the opposite side of driven plate 80 to provide additional opportunity for heat transfer but reducing the pumping effectiveness.

A valve 96 extends from reservoir 82 through a hole in the center of input shaft 72. Valve 96 can slide axially from the position shown in FIG. 3 to a position in which it blocks the flow of fluid from reservoir 82 into the working zone. To disengage the clutch, valve 96 is moved into this later position using electro-magnetic actuator 98 which is fixed to stationary housing 70. When the electro-magnetic force is not present, centrifugal forces acting on the fluid in reservoir 82 tend to push valve 96 into the engaged position shown in FIG. 3. A return spring may also be used.

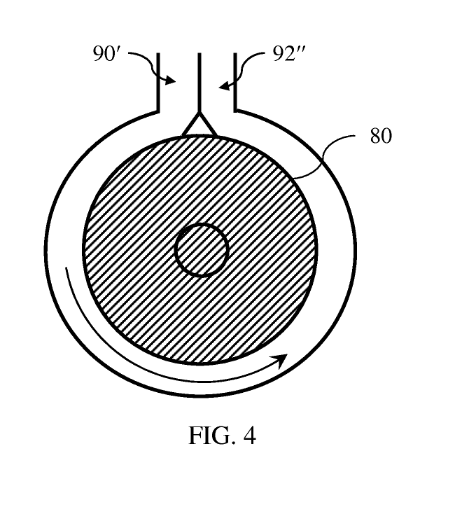

FIG. 4 shows an end view of an alternative embodiment. In this embodiment, the inlet 90′ and the outlet 92″ are each located on the perimeter of the stationary housing.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A viscous fan clutch comprising:
input and output shafts;
a drive plate fixed to the input shaft and having a first plurality of cylindrical ridges;
a driven plate fixed to the output shaft and having a second plurality of cylindrical ridges interspersed with the first plurality of ridges, the driving plate and driven plate defining a first fluid circuit to direct a working fluid between the first and second pluralities of ridges such that viscous shear exerts torque on the driven plate; and
a stationary housing, the driven plate and the stationary housing defining a second fluid circuit sealed from the first fluid circuit such that heat generated by the viscous shear is transferred through the driven plate to a cooling fluid in the second circuit.

2. The viscous fan clutch of claim 1 wherein the first fluid circuit includes a fluid reservoir.

3. The viscous fan clutch of claim 2 further comprising a valve configured to selectively block a flow of the working fluid from the reservoir.

4. The viscous fan clutch of claim 3 further comprising an electro-magnetic actuator fixed to the stationary housing and configured to bias the valve in an axial direction.

5. The viscous fan clutch of claim 1 further comprising a plurality of blades extending from the driven plate into the second fluid circuit and configured to propel the cooling fluid from an inlet port to an outlet port.

6. A clutch comprising:
a housing;
a driven plate supported for rotation within the housing, the driven plate and the housing defining a coolant circuit; and
a driving plate supported for rotation within the housing in proximity to the driven plate to define a working circuit sealed from the coolant circuit, the driving plate configured to circulate a working fluid through the working circuit.

7. The clutch of claim 6 wherein a plurality of driving plate cylindrical ridges are interspersed with a plurality of driven plate cylindrical ridges to define a working zone within the working circuit.

8. The clutch of claim 7 wherein the working circuit includes a radial passageway through the driven plate to convey working fluid from the working zone to a reservoir.

9. The clutch of claim 8 further comprising a valve configured to selectively block a flow of the working fluid from the reservoir.

10. The clutch of claim 9 further comprising an electro-magnetic actuator fixed to the housing and configured to move the valve axially.

11. The clutch of claim 6 further comprising a plurality of blades extending from the driven plate into the coolant circuit to propel a cooling fluid from an inlet port to an outlet port.

12. A powertrain comprising:
an engine having a crankshaft;
a radiator;
a fan configured to increase airflow through the radiator;
a clutch configured to selectively transfer power from the crankshaft to the fan and to pump a coolant from an inlet to an outlet in response to clutch engagement; and
plumbing configured to route the coolant from the engine to the inlet, from the outlet to the radiator, and from the radiator to the engine.

13. The powertrain of claim 12 wherein the clutch comprises:
a housing fixed to the engine;
a driven plate supported for rotation within the housing, the driven plate and the housing defining a coolant circuit between the inlet and the outlet; and
a driving plate supported for rotation within the housing in proximity to the driven plate to define a working circuit sealed from the coolant circuit, the driving plate configured to circulate a working fluid through the working circuit.

14. The powertrain of claim 13 wherein the clutch further comprises a plurality of blades extending from the driven plate into the coolant circuit to propel the cooling fluid from the inlet to the outlet.
